(19) United States
(12) Patent Application Publication
(10) Pub. No.: US 2003/0200299 A1
(43) Pub. Date: Oct. 23, 2003

(54) Method and system for providing pervasive computing services through a middle tier service provider utilizing public wired and/or wireless communication networks

(75) Inventor: James D. Jamison III, Aurora, CO (US)

Correspondence Address: Michael E. Hudzinski, FAY, SHARPE, FAGAN,, MINNICH & McKEE, LLP, 1100 Superior Avenue, Seventh Floor, Cleveland, OH, 44110-2518, US

(73) Assignee: International Business Machines Corporation

(21) Appl. No.: 10/128,375

(22) Filed: Apr. 23, 2002

(51) Int. Cl. G06F 15/173

(52) U.S. Cl. 709/223

(57) ABSTRACT

A business model is described for providing pervasive computing services to authorized corporate customers through a middle-tier service provider (MTSP) utilizing public wired and wireless communications networks such as the Internet. Entitled employees can securely connect via approved pervasive computing devices to corporate communications applications (e.g. e-mail, calendar, messaging) and browser accessible Intranet applications (e.g. field service, sales, document management) utilizing this invention. Secure connections are established between the device and the corporate infrastructure through a public wireless communication network utilizing the middle-tier service provider's infrastructure. Authorized corporations use the middle-tier service provider to perform all service fulfillment, service enablement and service account management functions in support of the contracted pervasive computing services. Corporations are alleviated from the continual and soaring investments in additional resources and infrastructure required to support a corporate pervasive computing strategy.

### BACKGROUND OF THE INVENTION

The present invention relates generally to the integration of systems and methods used in providing strategic outsourcing and e-business hosting services in the field of pervasive computing where authorized corporate customers utilize the services, infrastructure and processes of a middle-tier service provider (MTSP). In particular, the authorized corporate customers contract with the middle-tier service provider for service fulfillment, service enablement and service account management services in accordance with the invention.

Many corporations have seen the widespread procurement of pervasive computing devices such as personal digital assistants (PDAs), in form factors such as handheld, palm and pocketPC computing devices, by their employees. These devices allow employees to maintain a certain level of functionality without being tied to their traditional personal computing device such as desktop or notebook computers. Technology advances in this field such as the introduction of improved operating systems, enablement applications, the development of wireless modems, and the advent of Wireless Internet service providers, have made the use of PDAs more appealing in the corporate environment. While each of these advances has added increasing levels of functionality, no true comprehensive corporate services solution exists. In particular, for the corporate environment there has yet been the development and deployment of an integrated solution that addresses three key corporate business methods and systems, namely: service fulfillment, service enablement and service account management.

Corporate service fulfillment (CSF) in pervasive computing is based on traditional standard definitions of how to deliver the right resources, configured in the correct manner, to selected entitled employees. Existing product providers and service providers have systems and methods in place that allow individual employees to procure services and products, but they do not sufficiently address the corporate deployment need for built-in entitlement processes. Further, existing product and service providers are not sensitive to corporate application environment integration and do not support corporate users.

Corporate Service Enablement (CSE) comprises the systems and methods that are put in place to ensure secure connectivity and integration to existing corporate application environments for particular pervasive computing devices of entitled employees. Currently, technology exists and is emerging that provides secure connectivity utilizing secure protocols such as IPSEC. These technology advancements enable the possibility of secure connections from PDAs into corporations. However, these technology solutions do not address the methods aspect of allowing corporate secure access from public communications networks. Typically, to enable this technology requires a business to business relationship between a wireless service provider and a corporation to determine appropriate system integration, configuration parameters and security to ensure proper functionality of application transactions. In general, this requires some modifications to the existing corporate infrastructures since a predominance of the current wireless network service providers are not set up for direct connectivity for application to application transactions supporting business to businesses integration. This has traditionally been an area that service providers in the e-business hosting and strategic outsourcing markets have had to solve for traditional computing systems (host based, client/server, network computing) utilizing wired public and private communications networks. These solutions have required heavy investments by service providers into their business systems and methods to build the confidence of corporations to utilize the provider's infrastructure for business to business application integration services. Solution providers had to demonstrate their ability to securely connect a corporation's sensitive application environment to the Internet, and to be able to monitor that connection 24 hours a day, seven days a week, 52 weeks a year while providing corporate level service level agreement support for entitled employees. Building this credibility in a pervasive computing environment remains the critical foundation for a true corporate pervasive computing services implementation.

Service Account Management (SAM) remains the largest challenge to solution providers capable of delivering some forms of service fulfillment and service enablement to corporate customers. Service account management encompasses all of the systems and methods required to manage and administer corporate employee accounts, vendors, devices and applications associated with a pervasive computing services business model. This requires knowledge and an infrastructure designed specifically to address pervasive computing environments, provide the information required to analyze service performance, track entitled usage and make appropriate adjustments. In addition, service account management must be integrated with the service fulfillment and service enablement functions to be able to provide a high degree of customer satisfaction in a corporate services environment.

There is a need, therefore, in corporations for a system, method and article of manufacture that provides integrated service fulfillment, service enablement and service account management in full support of a corporate environment. The solution would enable corporations to define entitled employees who can access corporate communications applications and Intranet applications, enabling entitled employees to use and leverage a relatively inexpensive and wide spread medium such as a pubic wireless communications network, while at the same time allowing corporations to manage costs and provide an appropriate level of support to promote the utilization and deployment of pervasive computing devices in a corporate environment.

### SUMMARY OF THE INVENTION

The present invention provides Corporate Mobility Enablement (CME), in an integrated method, system, and article of manufacture for delivering service fulfillment, service enablement and service account management in a pervasive computing environment to a corporate customer through/by an associate Middle Tier Service Provider (MTSP). Through Corporate Mobility Enablement, entitled corporate employees receive the appropriate products, secure application access, and support they need to remain mobile and productive using a standard corporate application environment. Using the invention, corporations deploy, track and assess the utilization of entitled employees and their pervasive computing devices. In addition, corporations rely on the accountability and performance of the MTSP for meeting service level agreements that result in higher customer satisfaction in relation to CME services.

CME meets corporate requirements and standards for service fulfillment by using entitlements and profiles to ensure that the correct products are deployed and supported for only those selected corporate employees that have been designated as entitled employees. Only those authorized employees who have been entitled to receive services will have service accounts and thus will be provided with approved access and utilization of the services. Thus, a corporation will thereby effectively manage pervasive computing services fulfillment and deployment costs based upon contracted service agreements. In addition, the fulfillment process of the CME optimizes the time from service request to employee utilization because of the electronic workflow integration methodology used between the MTSP, customer and associated partners.

CME Service Enablement reduces the exposure of a corporation's corporate applications and infrastructure by providing a secure insulation layer between the corporation and the Internet, through authorization and authentication procedures that are performed by the associated MTSP. Corporations need not invest in infrastructure, personnel and processes to ensure that security breeches are detected and eliminated 24 hours a day, 7 days a week, 52 weeks a year for an additional untested third party network connection to their environment. The CME Service Enablement is based on an integrated interactive support and on-line self help and provides up-to-date status information, configuration updates and new product information. This enables authorized corporate customers and their entitled employees to establish and maintain the end user support model desired, optimizing the utilization of the CME services.

CME account management provides corporate decision makers with the information needed to evaluate the utilization, deployment, productivity value, and investment value of their pervasive computing services strategy. Through a series of service level agreements, reports and metrics provided by the MTSP through the CME process, corporations and the service provider can determine strategies and plans to maximize the Corporations utilization of pervasive computing technologies for their corporate employees.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention exists in the construction, arrangement, and combination of the various parts of the system, and/or the steps of the method, whereby the objects contemplated are attained as hereinafter more fully set forth, specifically pointed out in the claims, and illustrated in the accompanying drawings in which:

FIG. 1 is a flow chart of a CME service fulfillment method according to a preferred embodiment of the present invention;

FIG. 2 is a schematic illustration of a CME service fulfillment system according to a preferred embodiment of the present invention;

FIG. 3 is a flow chart of a CME service enablement method according to a preferred embodiment of the present invention;

FIG. 4 is a schematic illustration of a CME service enablement system according to a preferred embodiment of the present invention;

FIG. 5 is a flow chart of an account management method according to a preferred embodiment of the present invention; and,

FIG. 6 is a schematic illustration of a CME account management system according to a preferred embodiment of the present invention.

### DETAILED DESCRIPTION OF THE PREFERRED EMBODIMENT

The present invention includes a method, system, and article of manufacture for providing pervasive computing services through one or more middle tier service providers (MTSP) utilizing public wired and/or wireless communications networks for entitled corporate employees. In use of the invention, corporations enter into a contractual agreement with the middle tier service provider (MTSP) to entitle their employees to utilize the service for provisioning, support and access to corporate communications and Intranet applications. Following execution of the service agreement, the corporation becomes an “authorized” corporation. Authorized corporations are then given the ability to provide their authorized employees the right to request pervasive computing services. If approved, these authorized employees become entitled users of the contracted service and are granted approved pervasive computing hardware and software, access and support.

Interaction between the authorized corporation, authorized employees, entitled employees and the MTSP is carried out through the MTSP's Corporate Mobility Enablement Portal System (CMEPS). CMEPS is initially accessible through a public wired communications network using a universal graphical interface (UGI) such as a browser. After authorized users become entitled users, the CMEPS is accessible through a universal graphical interface (UGI) loaded into a personal digital assistant (PDA) such as a handheld device, palm device, pocket PC, etc., through a public wireless communications network. All information, applications and support are accessed through the CMEPS based on appropriate entitled user profile parameters and rights. CME service allows corporations to manage and track utilization and the costs of supporting corporate resources related to pervasive computing access from a public wireless communications network by entitled corporate employees.

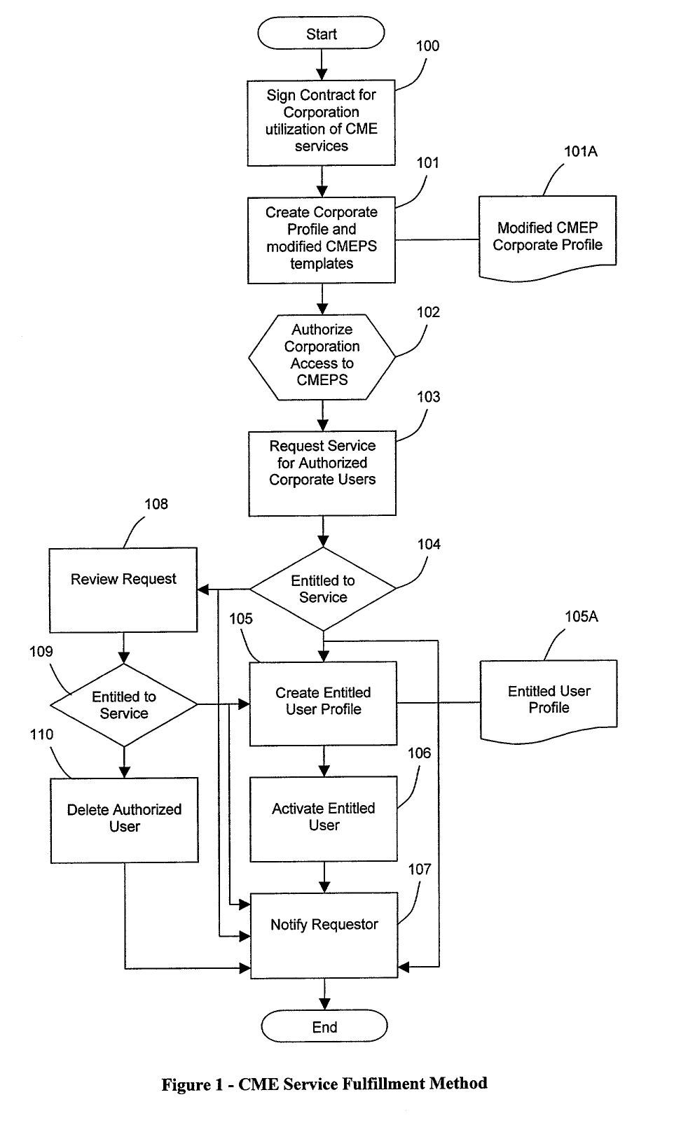

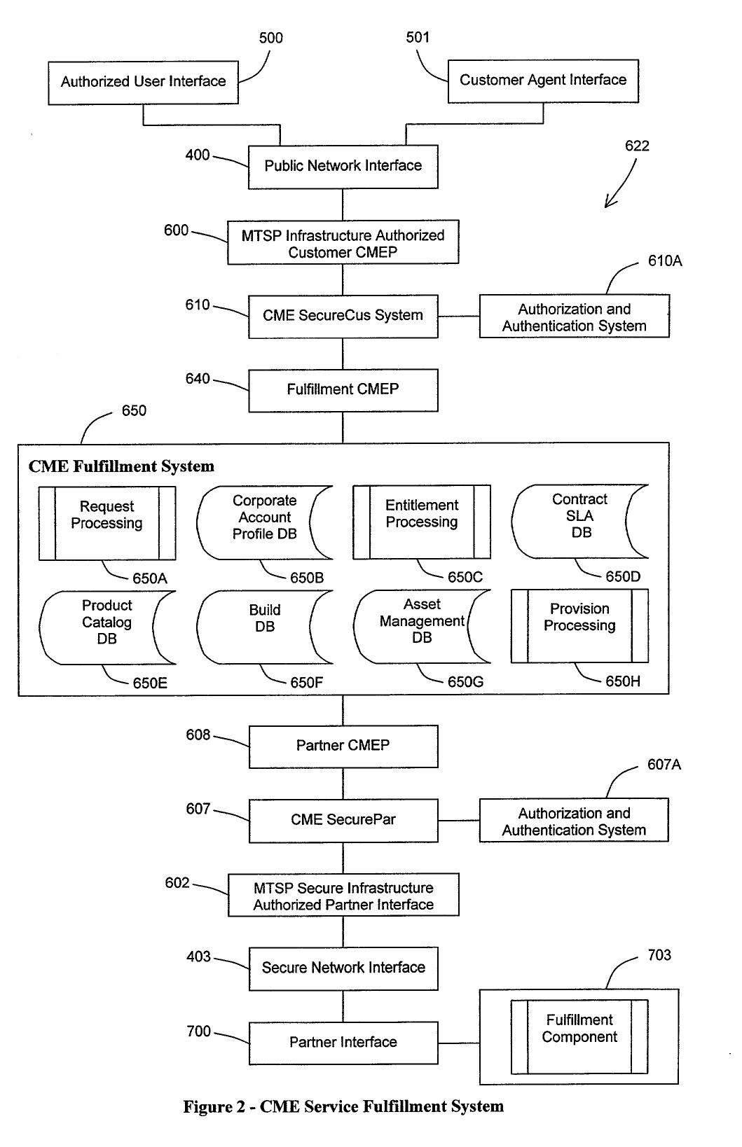

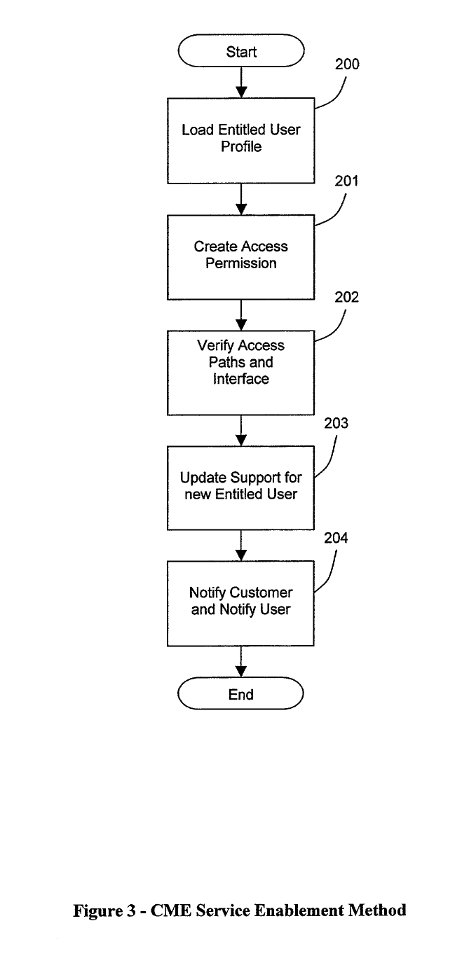

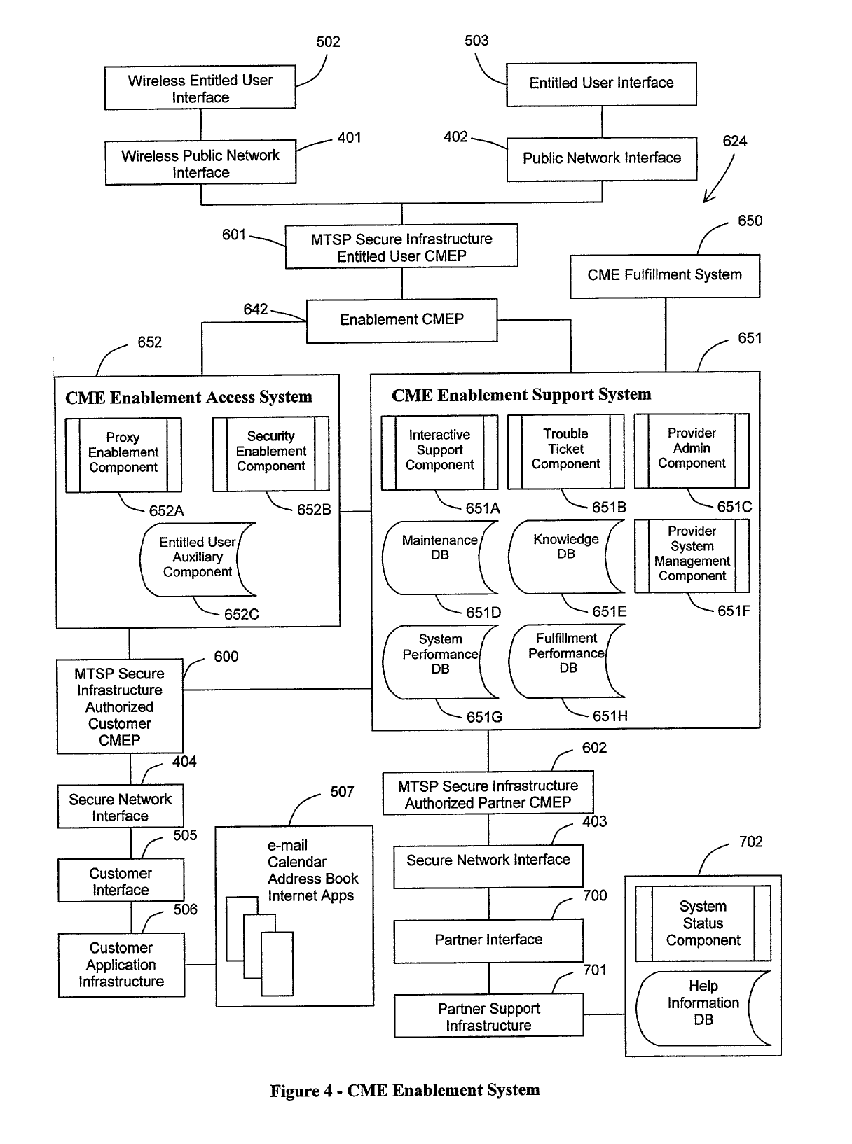

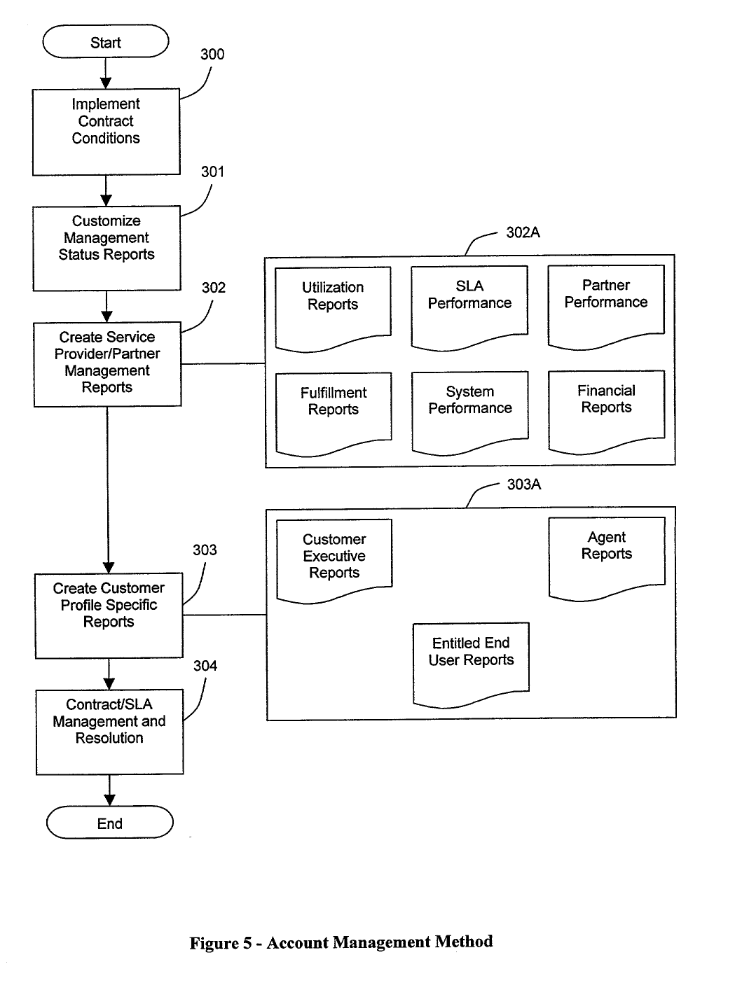

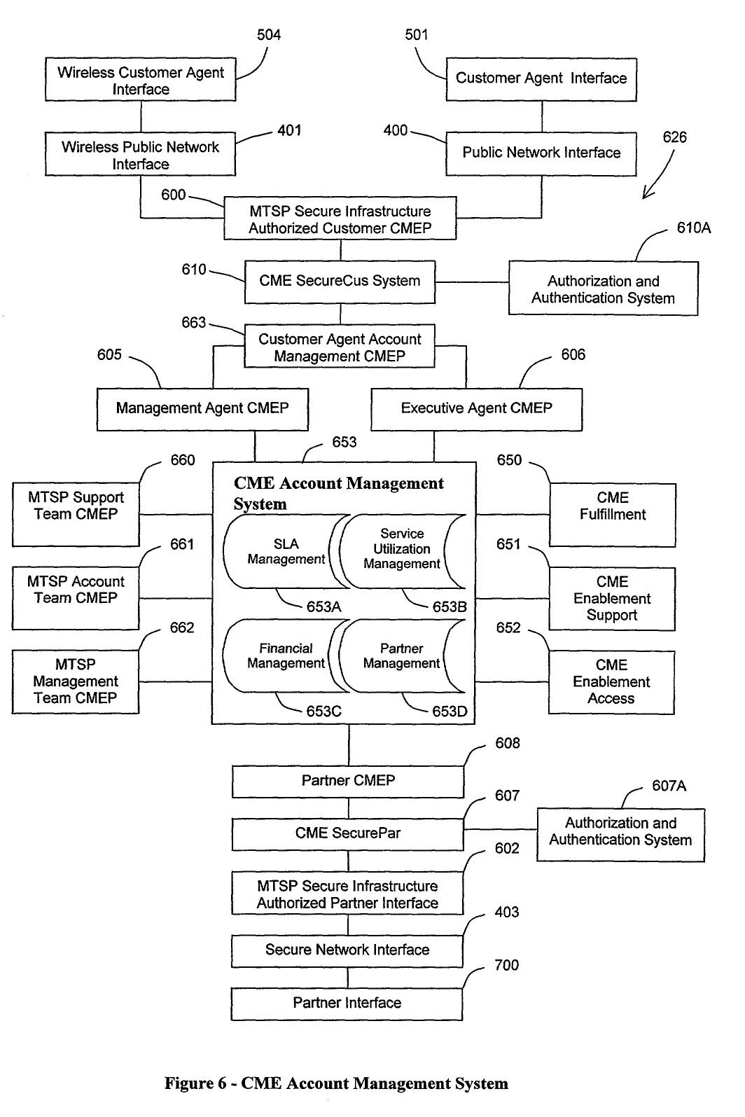

The present invention is implemented through the integration of a set of methods and systems by a middle tier service provider (MTSP). In a CME service fulfillment method, a business model and processes are provided for allowing authorized users to request entitlement for use of CME services. The preferred CME service fulfillment method is shown in FIG. 1. A CME service fulfillment system is an integrated computing system that processes entitlement requests for CME services. The preferred CME service fulfillment system is shown in FIG. 2. A CME service enablement method provides a business model and process for enabling entitled users to utilize CME services. The preferred CME service enablement method is shown in FIG. 3. A CME service enablement system is an integrated computing system that connects entitled users to access CMEPS infrastructure, applications and support, as shown in FIG. 4. A CME service account management method is a business model and process for managing and reporting CME services performance to authorized customer agents. A flow chart illustrating the preferred CME service account management method is shown in FIG. 5. Lastly, a CME service account management system is an integrated computing system that processes and reports on CME services utilization and overall account performance. The preferred CME service account management system will be described with reference FIG. 6.

A distinguishing factor of the present invention from prior art corporate and service provider solutions is that the subject CMEPS system is designed and implemented within a secure hosting infrastructure. The preferred secure hosting infrastructure integrates and accommodates: multiple customers; customer and system isolation as required; multiple types of computing systems and application; standard security technologies/policies and procedures (eg. firewalls, intrusion detection, security emergency response teams and processes); 24×7 administration, management, monitoring and support, ability to scale with demand; high availability through infrastructure and system redundancy as required; connectivity to public communications network, such as the Internet; and secure third party connections.

Referencing FIGS. 1 and 2, the CME Service fulfillment method and systems are presented including the primary steps and system components required. The CME fulfillment method and system described in this invention is one of the key distinguishing characteristics of this invention compared with other solutions to pervasive computing services. It provides an integrated workflow driven process that optimizes the time from service request to employee utilization.

The preferred CME service fulfillment method begins at step 100 where a corporation enters into an agreement with an MTSP for CME services. The agreement preferably encompasses the items listed in Table 1. The agreement and items listed are performed within the standard business and operational practices of the MTSP for service delivery best practices methodologies.

TABLE 1
Contract Agreement Items

| Item | Description |
|---|---|
| 1. | Period of the term of the contract |
| 2. | Billing rate for services |
| 3. | Authorized corporate locations, divisions, employees by geography |
| 4. | Wireless public communications geographic coverage area to be |
| | supported |
| 5. | Agreed to modified CMEPS based on MTSP templates |
| 6. | Baseline maximum number of accounts/users that will be supported |
| 7. | Baseline maximum number and type of devices per user that will |
| | be supported |
| 8. | Baseline maximum number of entitled employee profiles to be |
| | supported |
| 9. | Baseline maximum number and type of products and |
| | configurations to be supported |
| 10. | Baseline maximum number and type of applications to be accessed |
| 11. | Baseline identification of customer agents and associated profiles |
| 12. | CMEPS system availability |
| 13. | Agreed to responsibilities matrix, contact list and notification |
| | methodology for the interconnection of businesses, support of |
| | application environments being accessed, trouble ticket tracking |
| | and closure, problem determination and resolution |
| 14. | Service level agreements for fulfillment, end user customer |
| | support, customer satisfaction and other relevant metrics as agreed |
| | to and appropriate |
| 15. | Reporting, frequency and period of reports, scope of reports, types |
| | of reports, agreed to access to those reports based on customer |
| | agent profile |
| 16. | Resolution and compensation procedures for incorporating deltas |
| | to the baseline agreement |

At step 101 in FIG. 1, the MTSP modifies the standard CMEPS templates (101A) and stores the information into the CME Fulfillment system, 650 shown in FIG. 2 as part of the CME Service Fulfillment system 622. This modification provides a personal feel to the CMEPS for authorized corporate employees. The screens and information within the portal are based upon the agreements signed by the corporation and the MTSP. At step 102, the MTSP enables access to the modified CMEP. The MTSP assigns a unique corporate wide user ID and password that can be used by authorized users to request CME services. This assignment is incorporated into the CME SecureCus system in 610 and 620A. At step 103, the authorized user inputs basic information (for example, name, contact information, work location, employee type (based on approved profiles)) for requesting service. All information is entered through a modified CMEP, fulfillment CMEP 640, for the corporation utilizing a UGI, such as a browser, 500, and stored within the CME fulfillment system, 650. The CME fulfillment system, 650, is an integrated computing system that provides the processing and information storing functions. Table 2, lists and defines the elements that comprise the CME Fulfillment system.

TABLE 2
CME Fulfillment System Elements

| Item | Title | Description |
|---|---|---|
| 650A | Request Processing | Stores and processes all authorized user |
| | | requests |
| 650B | Corporate Account | Stores contract agreed to employee types, |
| | Profile | customer agent information, corporate |
| | | specific information |
| 650C | Entitlement | Stores and processes entitlement information |
| | Processing | including entitled user information |
| 650D | Contract SLA | Stores contract service level agreements and |
| | | contract information |
| 650E | Product Catalog | Stores authorized PDA devices and software |
| | | lists |
| 650F | Build | Stores and processes build and configuration |
| | | information |
| 650G | Asset Management | Tracks PDA and modem devices by entitled |
| | | user, activation accounts and billing (as |
| | | defined within contract) |
| 650H | Provision | Stores and processes all provisioning |
| | Processing | activities integrated with strategic partners |

The CMEP and CME fulfillment systems are implemented utilizing generally available portal technology, e-commerce technology, payment software suites, database technology, supply chain management software customer relationship management software and workflow products that have been customized by experienced personnel for this type of function. Since this type of integration is standard practice for e-business hosting and strategic outsourcing providers capable of implementing this invention, the details are omitted.

The CMEP is accessible through the public communications network, 400. At step 104, the entitlement process is executed. As part of the signed agreement, each authorized corporation designates an individual or group of individuals to serve as customer agents (CA) or authorizing agents (AA) for the entitlement process. These agents are the approving body for the corporation to control the number of authorized users who will become entitled corporate users based on the contract agreement and corporate guidelines. The entitlement process is an electronic workflow driven process that entails the MTSP notifying a customer agent of pending request that are ready for processing. Customer agents interact with the CME Fulfillment system, 650, through a customer agent UGI, 501, 504. The agent interfaces are provided access through a wireless and a wired public network interface, 401, 400. Depending upon the outcome at step 104, either step 105 or step 108 is executed. If approved, steps 105 and 106 are executed. If denied, step 108 is executed. At step 108, the denial is reviewed and, if the denial is confirmed, step 110 is selectively executed, as determined by step 109, in order to delete the user. If it is decided at step 109 to provide service to the user, step 105 is executed.

If the request is approved, then the requester is notified at step 107 after step 105 is executed. At step 105, the authorized user becomes an entitled user and is asked to complete their personalized profile, 105A. At a minimum this would include requesting approved products (if required) based on employee type, shipping address and service activation. The MTSP activation process is an electronic workflow driven process integrated with strategic CME service partners. The MTSP forwards batch hardware and software request to the appropriate vendor partners fulfillment system, 703. All information related to each request is stored within the fulfillment system, 650. Entitled users and customer agents can access the Fulfillment CMEP for status regarding individual requests or all requests as appropriate. The partners interact with the CME fulfillment system through a secure network connection, 403, through the partner CMEP, 608. Each approved vendor and system are given access rights to the CME fulfillment system, 650 through the CME SecurePar system, 607, 607A, for supporting fulfillment and CME service transactions. This would also include account activation by the wireless access service providers. The interface, 700, used by these vendors is a modified CMEP portal that provides appropriate views and data based on the type of transaction being supported. Once all steps of activation are completed the requesting user is notified.

If the request is initially denied, then the requester is notified that the request is on hold pending review, 107, and an automatic review process, 108, is initiated per contract agreements. Out of this process, a request can then be approved or denied as a final disposition. If denied, the original requestor is removed from the system and the requester is notified of the reason for the denial. If approved, the requester is notified and step 105 is executed.

Thus, utilization of CME services is managed according to contract agreement and costs for each corporation. This assists each corporation in meeting their pervasive computing services strategy goals. This is possible because the CME method and system described in this invention for fulfillment and entitlement is an integrated electronic workflow driven approach that distinguishes this invention from other disparate service provider and customer solutions.

Referring now to FIGS. 3 and 4, once an authorized user becomes an entitled user, the CME Enablement process is initiated. The CME Enablement process is primarily an internal MTSP process for the configuration, access enablement, deployment and support of entitled user's devices. The CME enablement system, 624, is a critical MTSP infrastructure component that enables entitled employees secure access to corporate communications and Intranet applications, and which also distinguishes this invention from other solutions. As with the CME fulfillment system, the CME Enablement system, 651 and 652, and Enablement CMEP, 642 are implemented utilizing generally available portal technology, virtual private network hardware and software, synchronization technology, customer contact center technology, customer relationship management, systems management and monitoring suites, database technology and workflow products that have been customized by experience personnel for this type of functionality. Since this type of integration is standard practice for e-business hosting and strategic outsourcing providers capable of implementing this invention, the details are omitted.

Access to the Enablement CMEP, 642, is via an MTSP Secure Infrastructure Entitled User CMEP, 601, that is connected to a Wireless Public Network Interface, 401, and a Wired Public Network Interface, 402. The wireless and wired network interfaces are connected to a Wireless Entitled User Interface, 502, and a Wired Entitled User Interface, 503, respectively.

The key elements of the CME Enablement system are the CME Enablement access system and the CME support system. The major components of those systems are listed in Table 3 and Table 4 respectively.

TABLE 3
CME Enablement Access System

| Item | Title | Description |
|---|---|---|
| 652A | Proxy Enablement | Provides secure application proxy and |
| | Component | synchronization functions as appropriate for |
| | | access into corporate application |
| | | environment |
| 652B | Security Enablement | Provides registration, authorization, |
| | Component | authentication, encryption and ID |
| | | management services |
| 652C | Auxiliary | Supplemental Applications, systems or |
| | Component | storage as required that is provided by MTSP |
| | | in support of corporate applications (e.g. |
| | | individual address books for contact |
| | | management) |

TABLE 4
CME Support System

| Item | Title | Description |
|---|---|---|
| 651A | Interactive Support | On-line interactive help, messaging, call |
| | | center functions typically provided by |
| | | service provider customer contact centers |
| 651B | Trouble Ticket | Problem submission and tracking system |
| | | used by MTSP and entitled users |
| 651C | Provider Admin | MTSP Administrative tool suite used in |
| | | support of the CME infrastructure, |
| | | applications and end user support |
| 651D | Maintenance | Updates, patches and enhancements for |
| | | download by entitled users based on profile |
| 651E | Knowledge | On-line database help for questions related to |
| | | problems, new products or general questions |
| | | related to CME |
| 651F | Provider System | Management and monitoring suite for MTSP |
| | Management | to monitor health and performance of CME |
| | | system and resolve any issues or make any |
| | | recommendations |
| 651G | System performance | Stores information and status on the |
| | | performance of all CMEP systems |
| 651H | Fulfillment | Stores information and status on the |
| | Performance | fulfillment process including vendor |
| | | performance and history |

At step 200 the entitled user profile is loaded into the enablement support system, 651. In steps 201 and 202 entitled user accounts are created and appropriate network paths are defined based on corporation and applications. These secure paths are defined between the CME enablement access system, 652 and the Customer application environment, 506 and 507. All traffic traverses a secure path utilizing the MTSP CMEP, 600 and the customer interface, 505 utilizing a secure network connection, 404. In step 203, the CME support system is updated with the entitled user profile and authorization for support services. In step 204, notification is sent to the customer agent and the authorized user.

Within the CME support system, 651, information related to the user is stored and processes are updated to reflect the addition of a new entitled employee record. Partners that are key to supporting the entitled users are connected to the CME support System, 651, through the MTSP Partner CMEP, 602. This interconnection of the partner support system, 702, and the MTSP CME support system, 651, provides the MTSP the advantage of being able to provide real time help, 702B, and information, 702A, to entitled users without having to re-invent the partner's valuable systems and information. A partner support system, 702, is connected to a partner support infrastructure, 701, which is in communication with a partner interface, 700. The partner interface, 700, to the MTSP partner CMEP, 602, is done through a secure network connection, 403.

Thus, entitled users are enabled to securely access key corporate applications. The high level of integration described by the CME enablement system in this invention enables corporations to permit secure access to corporate communications and Intranet applications and provide the required customer support without having to invest heavily into their own existing infrastructure and personnel. Entitled users receive the products and access required, remaining productive while they are remote and connected through a public wireless communications network. In addition, they receive the type of customer support that is required in a corporate environment. This integration of e-business hosting infrastructures and strategic outsourcing practices separates this invention from other proposed corporate and provider solutions to pervasive computing services.

Yet another aspect of the subject invention is the CME Account management method as diagrammed in FIG. 5 and the CME Account Management system 626 as shown in FIG. 6. This provides the corporate customer and the MTSP information on the utilization and performance of the services against agreed to service level agreements. This aspect of the invention delineates a true corporate customer targeted method and system from a consumer based or internal corporation based method and system. As with e-business hosting and strategic outsourcing, the MTSP is accountable for and is measured by customer satisfaction based on service level agreements. Depending upon the best practices methodologies implemented by the MTSP, this is where financial rewards and penalties are realized.

The CME account management process is initiated after the contract is signed and contract conditions are implemented at step 300. All relevant restrictions, limitations and conditions of service are incorporated into the CME system. In preparation for customer agent access, the MTSP customizes management reports, step 301. The management reports that are utilized are based on a standard set of templates that the MTSP uses for reporting status of the account to both MTSP management and to customer agents. Steps 302 and 303 are the implementation of those reports for a specific customer contract. Access to the account management system is done via either the Customer CMEP, 610 or the Partner CMEP, 608 from public communications networks. There are three categories of users of this system: customer agents, partners and MTSP personnel. Example reports that would be created for partners and MTSP personnel are shown in 302A.

Customer agents are authorized employees of the corporation that have been designated as contact personnel by the services agreement contract. These would include, contract support personnel, management and executives. Customer agents are presented with one of two views based on their profile; management (contract support personnel, management) CMEP, 605, or executive (executives) CMEP, 606. The difference between the views lies within the type of reports that each agent is authorized to access and view. Access to the management CMEP and the executive CMEP is provided through a customer agent account management CMEP, 663, that is in communication with the CME SecureCus System, 610. Example reports that would be created for Customer management agents are shown in 303A. Authorization and authentication for each customer agent trying to access the system is done through the CME SecureCus system, 610 and 620A.

Partners are those MTSP partners who have been contracted with to provide product and service support in relation to the provider's CME service. Each partner assigns authorized employees who will interact with the MTSP for delivering the appropriate level of support to the MTSP. These authorized partners are provided access to the partner related information to evaluate the service they are delivering and how they are performing based on MTSP established criteria. This information is used by the partner and the MTSP to optimize delivery of services between the two organizations. Because of the integration with other aspects of this invention, 650 and 651, this single portal view allows the MTSP and the partner to work from the same information and resolve any service delivery issues, step 304. Access for partners is done via the MTSP authorized Interface 602. Authorization and authentication is performed by Partner CMEP 608.

Within the MTSP, multiple portal views concerning the performance of all CME accounts are provided. At a minimum, three types of portals are supported: MTSP support team CMEP, MTSP Account team CMEP and MTSP Management team CMEP. The support team CMEP, 660, provides those provider employees that are supporting CME services access to information that will assist them in evaluating and improving the delivery of services and enhance system performance. The account team CMEP, 661, provides the account team responsible with the primary interface to a customer access to financial performance, service level agreements and partner performance information that would affect the quality and perceived quality of services being delivered. In addition, the account team has access to up-to-date information that is needed when interacting and providing status to the customer on the system availability, utilization and overall performance of contracted services and resolving any issues associated with the service at step 304. The management team CMEP, 662, provides the CME services management team access to information across all CME accounts. The team can use this information to make strategic decisions for expansion, enhancement and change of CME services.

All information related to CME Account management is processed and stored within the CME Account Management subsystem, 653. The major elements of this system are defined within Table 5. The CME Account Management subsystem, 653, and associated portals, 605, 606, 660, 661 and 662 are implemented utilizing generally available portal technology, financial software, customer relationship management software, database technology and workflow products that have been customized by experienced personnel for this type of functionality. Since this type of integration is standard practice for e-business hosting and strategic outsourcing providers capable of implementing this invention, the details are omitted.

TABLE 5
CME Account Management Elements

| Item | Title | Description |
|---|---|---|
| 653A | SLA performance | Aggregate status of MTSP performance |
| | | against defined Service Level Agreement |
| 653B | Service Utilization | Aggregate information on utilization of |
| | | service by profile, device, user, geography |
| | | and partner services |
| 653C | Financial | Processing, storing and status of financial |
| | Management | expenditures and recoveries incurred by |
| | | MTSP by service agreement for each |
| | | corporation and partner |
| 653D | Partner Performance | Aggregate status of partner performance |
| | | against agreed to terms |

In summary, the solution provided by concepts of the present invention provides each interested party (customer agents, partners, and MTSP) with up-to-date and consistent information relating to the delivery of CME services. This invention's integrated method and system provides for improved communication and improved customer satisfaction compared to other similar solutions. Authorized personnel can resolve issues, problems, discrepancies and desired modifications based off of the same anytime-accessible information. Thus, the integrated method and system for account management defined within this invention is a distinct competitive advantage for both MTSP and the customer compared to traditional account management support solutions.

Other solutions have attempted to address pervasive computing services through technology advancement and through disparate point solutions. In particular, for the corporate environment there has yet been the development and deployment of an integrated solution that addresses three key corporate business methods and systems: service fulfillment, service enablement and service account management. As previously described, the present invention provides an integrated business method system, and article of manufacture for service fulfillment, service enablement and service account management. In particular, preferably, the invention: is based on the middle tier service provider (MTSP) implementation model; utilizes entitlements and profiles to ensure that the correct products are deployed and supported for only those corporate employees that have been designated as entitled employees, through the CME Service Fulfillment business method and system; provides a secure insulation layer between the corporation and the Internet, through authorization and authentication procedures that are performed by the MTSP, through the CME Service Enablement business method and system; provides decision makers with the information needed to evaluate the utilization, deployment, productivity value and investment value of their pervasive computing services strategy, through CME Service Account Management; and, defines a Corporate Mobility Enablement Portal System utilizing a secure hosting infrastructure for all interaction between entitled users, corporate infrastructures, MTSP and partners.

The above describes the preferred embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

What is claimed is:

1. An integrated system for enabling computing services for use by associated pervasive computing devices through an associated middle tier service provider, the system comprising:
a CME service enablement system providing a secure insulation layer including authorization procedures and authentication procedures, the authorization procedures and authentication procedures being adapted to be performed by the associated middle tier service provider; and,
a CME portal system in communication with the CME service enablement system and utilizing a secure hosting infrastructure for all interaction between entitled users of the integrated system, corporate infrastructures, the associated middle tier service provider and partners.

2. The integrated system for enabling computing services as set forth in claim 1 wherein the CME portal system comprises:
an enablement CMEP portal in communication with the CME service enablement system;
a middle tier service provider secure infrastructure entitled user CME portal in communication with the enablement CMEP portal and connected to at least one network interface;
a middle tier service provider secure infrastructure authorized customer CME portal in communication with the CME service enablement system and connected to at least one secure network interface; and,
a middle tier service provider secure infrastructure authorized partner CME portal in communication with the CME service enablement system and connected to at least one secure network interface.

3. The integrated system for enabling computing services as set forth in claim 1 wherein the CME portal system is connected to and utilizes at least one of:
an associated public wired communications network;
an associated public wireless communications network; and,
an associated set of interconnected computer networks.

4. The integrated system for enabling computing services as set forth in claim 3 wherein the set of interconnected computer networks comprises the Internet.

5. The integrated system for enabling computing services as set forth in claim 1 wherein the CME service enablement system comprises:
a wireless user interface;
a wireless public interface connected to the wireless user interface;
a wired user interface;
a wired public interface connected to the wired user interface;
a CME enablement access system in communication with the CME portal system);
a CME enablement support system in communication with the CME portal system;
a CME fulfillment system in communication with the CME enablement support system;
a first secure communications network interface in communication with the CME portal system;
a customer interface in communication with the first secure communications network interface;
a customer application infrastructure in communication with the customer interface;
a second secure communications network interface in communication with the CME portal system;
a partner interface in communication with the second secure communications network interface; and,
a partner support infrastructure in communication with the partner interface.

6. The integrated system for enabling computing services as set forth in claim 5 wherein the CME fulfillment system comprises:
a request processing component;
a corporate account profile database;
an entitlement processing component;
a contract SLA database;
a product catalog database;
a build database;
an asset management database; and,
a provision processing component.

7. The integrated system for enabling computing services as set forth in claim 5 wherein the CME enablement access system comprises:
a proxy enablement component;
a security enablement component; and,
an entitled user auxiliary component.

8. The integrated system for enabling computing services as set forth in claim 5 wherein the CME enablement support system comprises:
an interactive support component;
a trouble ticket component;
a provider administration component;
a maintenance database;
a knowledge database;
a provider system management component;
a system performance database; and,
a fulfillment performance database.

9. An integrated system for deploying computing products for use by associated pervasive computing devices through a middle tier service provider, the system comprising:
a CME service fulfillment system that utilizes associated entitlements and profiles to ensure that correct products are deployed and supported for only entitled employees; and,
a CME account management system;
wherein the CME service fulfillment system and CME account management system function independently of each other offering respective services of the integrated system.

10. The integrated system for deploying computing products as set forth in claim 9 wherein the CME service fulfillment system and the CME account management system utilize at least one of:
an associated public wired communications network;
an associated public wireless communications network; and,
an associated set of interconnected computer networks.

11. The integrated system for deploying computing products as set forth in claim 10 wherein the set of interconnected computer networks comprises the Internet.

12. The integrated system for deploying computing products as set forth in claim 9 wherein the CME service fulfillment system comprises:
a user interface;
a customer agent interface;
a public communications network interface connected to the user interface and the customer agent interface;
a middle tier service provider infrastructure authorized customer CME portal connected to the public communications network interface;
a CME SecureCus system in communication with the middle tier service provider infrastructure authorized customer CME portal, wherein the SecureCus system provides authorization and authentication for authorized users and authorized customer agents;
a fulfillment CME portal in communication with the CME SecureCus system;
a CME fulfillment system in communication with the fulfillment CME portal;
a partner CME portal in communication with the CME fulfillment system;
a CME SecurePar system in communication with the partner CME portal, wherein the SecurePar system provides access rights to authorized partners;
an authorization and authentication system in communication with the CME SecureCus system and the CME SecurePar system;
a middle tier service provider secure infrastructure authorized partner interface in communication with the CME SecurePar system;
a secure communications network interface in communication with the middle tier service provider secure infrastructure authorized partner interface;
a second partner interface in communication with the secure communications network interface; and,
a fulfillment component in communication with the second partner interface.

13. The integrated system for deploying computing products as set forth in claim 12 wherein the CME fulfillment system comprises:
a request processing component;
a corporate account profile database;
an entitlement processing component;
a contract SLA database;
a product catalog database;
a build database;
an asset management database; and,
a provision processing component.

14. The integrated system for deploying computing products as set forth in claim 9 wherein the CME account management system comprises:
a wireless customer agent interface;
a wireless public communications network interface in communication with the wireless customer agent interface;
a wired customer agent interface;
a wired public communications network interface in communication with the wired public communications network interface;
a middle tier service provider secure infrastructure authorized customer CME portal in communication with the wireless public communications network interface and the wired public communications network interface;
a CME SecureCus system in communication with the middle tier service provider secure infrastructure authorized customer CME portal, wherein the SecureCus system provides authorization and authentication for authorized users and authorized customer agents;
a customer agent account management CME portal in communication with the CME SecureCus system;
a management agent CME portal in communication with the customer agent account management CME portal;
an executive agent CME portal in communication with the customer agent account management CME portal;
a CME account management subsystem in communication with the management agent CME portal and the executive agent CME portal;
a middle tier service provider support team CME portal in communication with the CME account management subsystem;
a middle tier service provider account team CME portal in communication with the CME account management subsystem;
a middle tier service provider management team CMEP in communication with the CME account management subsystem;
a CME fulfillment system in communication with the CME account management subsystem;
a CME enablement support system in communication with the CME account management subsystem;
a CME enablement access system in communication with the CME account management subsystem;
a partner CME portal in communication with the CME account management subsystem;
a CME SecurePar system in communication with the partner CME portal, wherein the SecurePar system provides access rights to authorized partners;
an authorization and authentication system in communication with the CME SecureCus system and the CME SecurePar system;
a middle tier service provider secure infrastructure authorized partner interface in communication with the CME SecurePar system;
a secure communications network interface in communication with the middle tier service provider secure infrastructure authorized partner interface; and,
a second partner interface in communication with the secure communications network interface.

15. The integrated system for deploying computing products as set forth in claim 14 wherein the CME fulfillment system comprises:
a request processing component;
a corporate account profile database;
an entitlement processing component);
a contract SLA database;
a product catalog database;
a build database;
an asset management database; and,
a provision processing component.

16. The integrated system for deploying computing products as set forth in claim 14 wherein the CME enablement access system comprises:
a proxy enablement component;
a security enablement component; and,
an entitled user auxiliary component.

17. The integrated system for deploying computing products as set forth in claim 14 wherein the CME enablement support system comprises:
an interactive support component;
a trouble ticket component;
a provider administration component;
a maintenance database;
a knowledge database;
a provider system management component;
a system performance database; and,
a fulfillment performance database.

18. An integrated system for providing pervasive computing services through a middle tier service provider, the system comprising:
a CME service fulfillment system that utilizes associated entitlements and profiles to ensure that correct products are deployed and supported for only entitled employees;
a CME service enablement system providing a secure insulation layer including authorization procedures and authentication procedures, the authorization procedures and authentication procedures being adapted to be performed by the associated middle tier service provider; and,
a CME account management system.

19. The integrated system for providing pervasive computing services as set forth in claim 18 wherein the CME service fulfillment system, the CME service enablement system and the CME account management system utilize at least one of:
an associated public wired communications network;
an associated public wireless communications network; and,
an associated set of interconnected computer networks.

20. The integrated system for providing pervasive computing services as set forth in claim 19 wherein the set of interconnected computer networks comprises the Internet.

21. The integrated system for providing pervasive computing services as set forth in claim 18 wherein the CME service fulfillment system comprises:
a user interface;
a customer agent interface;
a public communications network interface in communication with the user interface and the customer agent interface;
a middle tier service provider infrastructure authorized customer CME portal in communication with the public communications network interface;
a CME SecureCus system in communication with the middle tier service provider infrastructure authorized customer CME portal, wherein the SecureCus system provides authorization and authentication for authorized users and authorized customer agents;
a fulfillment CME portal in communication with the CME SecureCus system;
a CME fulfillment system in communication with the fulfillment CME portal;
a partner CME portal in communication with the CME fulfillment system;
a CME SecurePar system in communication with the partner CME portal, wherein the SecurePar system provides access rights to authorized partners;
an authorization and authentication system in communication with the CME SecureCus system and the CME SecurePar system;
a middle tier service provider secure infrastructure authorized partner interface in communication with the CME SecurePar system;
a secure communications network interface in communication with the middle tier service provider secure infrastructure authorized partner interface;
a second partner interface in communication with the secure communications network interface; and,
a fulfillment component in communication with the second partner interface.

22. The integrated system for providing pervasive computing services as set forth in claim 21 wherein the CME fulfillment system comprises:
a request processing component;
a corporate account profile database;
an entitlement processing component;
a contract SLA database;
a product catalog database;
a build database;
an asset management database; and,
a provision processing component.

23. The integrated system for providing pervasive computing services as set forth in claim 18 wherein the CME service enablement system comprises:
a wireless user interface;
a wireless public interface in communication with the wireless user interface;
a wired user interface;
a wired public interface in communication with the wired user interface;
a middle tier service provider secure infrastructure entitled user CME portal in communication with the wireless public interface and the wired public interface;
an enablement CME portal in communication with the middle tier service provider secure infrastructure entitled user CME portal;
a CME enablement access system in communication with the enablement CME portal;
a CME enablement support system in communication with the enablement CME portal;
a CME fulfillment system in communication with the CME enablement support system;
a middle tier service provider infrastructure authorized customer CME portal in communication with the CME enablement support system and the CME enablement access system;
a first secure communications network interface in communication with the middle tier service provider infrastructure authorized customer CME portal;
a customer interface in communication with the first secure communications network interface;
a customer application infrastructure in communication with the customer interface;
a middle tier service provider secure infrastructure authorized partner CME portal in communication with the CME enablement support system;
a second secure communications network interface in communication with the middle tier service provider secure infrastructure authorized partner CME portal;
a partner interface in communication with the second secure communications network interface; and,
a partner support infrastructure in communication with the partner interface.

24. The integrated system for providing pervasive computing services as set forth in claim 23 wherein the CME fulfillment system comprises:
a request processing component;
a corporate account profile database;
an entitlement processing component;
a contract SLA database;
a product catalog database;
a build database;
an asset management database; and,
a provision processing component.

25. The integrated system for providing pervasive computing services as set forth in claim 23 wherein the CME enablement access system comprises:
a proxy enablement component;
a security enablement component; and,
an entitled user auxiliary component.

26. The integrated system for providing pervasive computing services as set forth in claim 23 wherein the CME enablement support system comprises:
an interactive support component;
a trouble ticket component;
a provider administration component;
a maintenance database;
a knowledge database;
a provider system management component;
a system performance database; and,
a fulfillment performance database.

27. The integrated system for providing pervasive computing services as set forth in claim 23 further comprising:
a plurality of customer applications in communication with the customer application infrastructure; and,
a partner support system in communication with the partner support infrastructure.

28. The integrated system for providing pervasive computing services as set forth in claim 18 wherein the CME account management system comprises:
a wireless customer agent interface;
a wireless public communications network interface in communication with the wireless customer agent interface;
a wired customer agent interface;
a wired public communications network interface in communication with the wired public communications network interface;
a middle tier service provider secure infrastructure authorized customer CME portal in communication with the wireless public communications network interface and the wired public communications network interface;
a CME SecureCus system in communication with the middle tier service provider secure infrastructure authorized customer CME portal, wherein the SecureCus system provides authorization and authentication for authorized users and authorized customer agents;
a customer agent account management CME portal in communication with the CME SecureCus system;
a management agent CME portal in communication with the customer agent account management CME portal;
an executive agent CME portal in communication with the customer agent account management CME portal;
a CME account management subsystem in communication with the management agent CME portal and the executive agent CME portal;
a middle tier service provider support team CME portal in communication with the CME account management subsystem;
a middle tier service provider account team CME portal in communication with the CME account management subsystem;
a middle tier service provider management team CMEP in communication with the CME account management subsystem;
a CME fulfillment system in communication with the CME account management subsystem;
a CME enablement support system in communication with the CME account management subsystem;
a CME enablement access system in communication with the CME account management subsystem;
a partner CME portal in communication with the CME account management subsystem;
a CME SecurePar system in communication with the partner CME portal, wherein the SecurePar system provides access rights to authorized partners;
an authorization and authentication system in communication with the CME SecureCus system and the CME SecurePar system;
a middle tier service provider secure infrastructure authorized partner interface in communication with the CME SecurePar system;
a secure communications network interface in communication with the middle tier service provider secure infrastructure authorized partner interface; and,
a second partner interface in communication with the secure communications network interface.

29. The integrated system for providing pervasive computing services as set forth in claim 28 wherein the CME fulfillment system comprises:
a request processing component;
a corporate account profile database;
an entitlement processing component;
a contract SLA database;
a product catalog database;
a build database;
an asset management database; and,
a provision processing component.

30. The integrated system for providing pervasive computing services as set forth in claim 28 wherein the CME enablement access system comprises:
a proxy enablement component;
a security enablement component; and,
an entitled user auxiliary component.

31. The integrated system for providing pervasive computing services as set forth in claim 28 wherein the CME enablement support system comprises:
an interactive support component;
a trouble ticket component;
a provider administration component;
a maintenance database;
a knowledge database;
a provider system management component;
a system performance database; and,
a fulfillment performance database.

32. An integrated method for CME service fulfillment and management comprising the steps of:
(a) providing a middle tier service provider for CME services;
(b) modifying standard CME portal system templates and storing the modified templates into a CME fulfillment system, wherein the modifying provides a personal feel to the CME portal system for authorized corporate employees;
(c) enabling, by the middle tier service provider, access to the modified CME portal by assigning a unique corporate wide user ID and password that can be used by authorized users to request CME services;
(d) inputting, by an authorized user, identifying information such as, but not limited to, name, contact information, work location and employee type for requesting service, wherein the information is inputted through a modified CME portal utilizing a UGI, such as a browser, and stored within a CME fulfillment system;
(e) executing an entitlement process, wherein the entitlement process is an electronic workflow driven process that entails the middle tier service provider notifying a customer agent of pending requests that are ready for processing and customer agents interact with the CME Fulfillment system through a UGI, and, depending upon an outcome of the entitlement process, steps for an entitled user are selectively executed comprising:
(i) entitling the authorized user as an entitled user;
(ii) completing, by the entitled user, a personalized profile, providing information including, but not limited to, selectively requested approved products, shipping address and service activation;
(iii) forwarding, by the middle tier service provider, batch hardware and software requests to appropriate vendor partners fulfillment systems;
(iv) storing within the fulfillment system information related to each request;
(v) interacting, by the vendor partners, with the CME fulfillment system through a secure communications network connection through a partner CME portal;
(vi) giving, to each approved vendor and system, access rights to the CME fulfillment system through a CME SecurePar system for supporting fulfillment and CME service transactions; and,
(vii) activating the entitled user;
or steps for a non-entitled user are selectively executed comprising:
(viii) initiating an automatic review process according to contract agreements;
(ix) approving or denying the request;
(x) executing steps (i)-(vii) for an entitled user if the request is approved; and,
(xi) selectively removing the authorized user from the CME portal system if the request is denied; and,
(f) notifying the authorized user of approval of the request or of a reason for denial of the request.

33. The integrated method for CME service fulfillment and management as set forth in claim 32, further comprising the steps of:
(g) incorporating, into a CME system, relevant restrictions, limitations and conditions of service according to an account contract);
(h) customizing, by a middle tier service provider, a set of management reports based on a standard set of templates that the middle tier service provider uses for reporting status of the account to both middle tier service provider management and partners and to customer agents;
(i) creating, by the middle tier service provider, customer contract specific provider and partner management reports;
(j) creating, by the middle tier service provider, customer profile specific reports; and,
(k) resolving, by the middle tier service provider and partners, any service delivery issues, wherein the middle tier service provider and partners work from the same information.

34. An integrated method for CME service enablement comprising the steps of:
(a) loading an entitled user profile into an enablement support system;
(b) creating entitled user accounts;
(c) defining secure communications network paths based on the entitled user's corporation and applications, wherein the secure paths are defined between a CME enablement access system and a customer application environment, and wherein all communications network traffic traverses a secure path utilizing a middle tier service provider CME portal, and wherein the customer interface utilizes a secure communications network connection;
(d) storing information and updating processes related to the entitled user in a CME support system to reflect the addition of a new entitled employee record;
(e) connecting partners for supporting the entitled user to the CME support System through the middle tier service provider CME portal, wherein a partner interface to the middle tier service provider CME portal is through a secure communications network connection, and wherein entitled users receive required products and access while they are remote and connected through a public wireless communications network; and,
(f) selectively notifying at least one of the entitled user and the customer.

35. An integrated method for deploying computing products to pervasive computing devices comprising the steps of:
(a) providing a middle tier service provider for CME services;
(b) modifying, by the middle tier service provider, standard CME portal system templates and storing the modified templates into a CME fulfillment system, wherein the modifying provides a personal feel to the CME portal system for authorized corporate employees;
(c) enabling, by the middle tier service provider, access to the modified CME portal by assigning a unique corporate wide user ID and password that can be used by authorized users to request CME services;
(d) inputting, by an authorized user, identifying information such as, but not limited to, name, contact information, work location and employee type for requesting service, wherein the information is inputted through the modified CME portal utilizing a UGI, such as a browser, and stored within a CME fulfillment system;
(e) executing an entitlement process, wherein the entitlement process is an electronic workflow driven process that entails the middle tier service provider notifying a customer agent of pending requests that are ready for processing and customer agents interact with the CME Fulfillment system through a UGI, and, depending upon an outcome of the entitlement process, steps for an entitled user are selectively executed comprising:
(i) entitling the authorized user as an entitled user;
(ii) completing, by the entitled user, a personalized profile, providing information including, but not limited to, selectively requested approved products, shipping address and service activation;
(iii) forwarding, by the middle tier service provider, batch hardware and software requests to appropriate vendor partners fulfillment systems;
(iv) storing within the fulfillment system information related to each request;
(v) interacting, by the vendor partners, with the CME fulfillment system through a secure communications network connection through a partner CME portal;
(vi) giving each approved vendor and system access rights to the CME fulfillment system through a CME SecurePar system for supporting fulfillment and CME service transactions; and,
(vii) activating the entitled user;
or steps for a non-entitled user are selectively executed comprising:
(viii) initiating an automatic review process according to contract agreements;
(ix) approving or denying the request;
(x) executing steps (i)-(vii) for an entitled user if the request is approved; and
(xi) selectively removing the authorized user from the CME portal system if the request is denied;
(f) notifying the authorized user of approval of the request or of a reason for denial of the request;
(g) loading an entitled user profile into an enablement support system;
(h) creating entitled user accounts;
(i) defining secure communications network paths based on the entitled user's corporation and applications, wherein the secure paths are defined between a CME enablement access system and a customer application environment, and wherein all communications network traffic traverses a secure path utilizing a middle tier service provider CME portal, and wherein the customer interface utilizes a secure communications network connection;
(j) storing information and updating processes related to the entitled user in a CME support system to reflect the addition of a new entitled employee record;
(k) connecting partners for supporting the entitled user to the CME support System through the middle tier service provider CME portal, wherein a partner interface to the middle tier service provider CME portal is through a secure communications network connection, and wherein entitled users receive required products and access while they are remote and connected through a public wireless communications network;
(l) selectively notifying at least one of the entitled user and the customer;
(m) incorporating relevant restrictions, limitations and conditions of service into a CME system according to an account contract;
(n) customizing, by a middle tier service provider, a set of management reports based on a standard set of templates that the middle tier service provider uses for reporting status of the account to both middle tier service provider management and partners and to customer agents;
(o) creating, by the middle tier service provider, customer contract specific provider and partner management reports;
(p) creating, by the middle tier service provider, customer profile specific reports; and,
(q) resolving, by the middle tier service provider and partners, any service delivery issues, wherein the middle tier service provider and partners work from the same information; wherein steps (a)-(q) are integrated in a manner wherein steps (a)-(f) provide for CME service fulfillment, steps (g)-(l) provide for CME service enablement, and steps (m)-(q) provide for account management.

36. An article of manufacture comprising a program storage medium readable by a computer and embodying one or more instructions executable by the computer to perform integrated method steps for executing commands to perform CME service fulfillment and management, the integrated method comprising the steps of:
(a) providing a middle tier service provider for CME services;
(b) modifying standard CME portal system templates and storing the modified templates into a CME fulfillment system, wherein the modifying provides a personal feel to the CME portal system for authorized corporate employees;
(c) enabling, by the middle tier service provider, access to the modified CME portal by assigning a unique corporate wide user ID and password that can be used by authorized users to request CME services;
(d) inputting, by an authorized user, identifying information such as, but not limited to, name, contact information, work location and employee type for requesting service, wherein the information is inputted through a modified CME portal utilizing a UGI, such as a browser, and stored within a CME fulfillment system;
(e) executing an entitlement process, wherein the entitlement process is an electronic workflow driven process that entails the middle tier service provider notifying a customer agent of pending requests that are ready for processing and customer agents interact with the CME Fulfillment system through a UGI, and, depending upon an outcome of the entitlement process, steps for an entitled user are selectively executed comprising:
(i) entitling the authorized user as an entitled user;
(ii) completing, by the entitled user, a personalized profile, providing information including, but not limited to, selectively requested approved products, shipping address and service activation;
(iii) forwarding, by the middle tier service provider, batch hardware and software requests to appropriate vendor partners fulfillment systems;
(iv) storing within the fulfillment system information related to each request;
(v) interacting, by the vendor partners, with the CME fulfillment system through a secure communications network connection through a partner CME portal;
(vi) giving, to each approved vendor and system, access rights to the CME fulfillment system through a CME SecurePar system for supporting fulfillment and CME service transactions; and
(vii) activating the entitled user;
or steps for a non-entitled user are selectively executed comprising:
(viii) initiating an automatic review process according to contract agreements;
(ix) approving or denying the request;
(x) executing steps (i)-(vii) for an entitled user if the request is approved; and,
(xi) selectively removing the authorized user from the CME portal system if the request is denied; and,
(f) notifying the authorized user of approval of the request or of a reason for denial of the request.

37. The article of manufacture as set forth in claim 36, further comprising the steps of:
(g) incorporating, into a CME system, relevant restrictions, limitations and conditions of service according to an account contract);
(h) customizing, by a middle tier service provider, a set of management reports based on a standard set of templates that the middle tier service provider uses for reporting status of the account to both middle tier service provider management and partners and to customer agents;
(i) creating, by the middle tier service provider, customer contract specific provider and partner management reports;
(j) creating, by the middle tier service provider, customer profile specific reports; and,
(k) resolving, by the middle tier service provider and partners, any service delivery issues, wherein the middle tier service provider and partners work from the same information.

38. An article of manufacture comprising a program storage medium readable by a computer and embodying one or more instructions executable by the computer to perform integrated method steps for executing commands to perform CME service enablement, the integrated method comprising the steps of:
(a) loading an entitled user profile into an enablement support system;
(b) creating entitled user accounts;
(c) defining secure communications network paths based on the entitled user's corporation and applications, wherein the secure paths are defined between a CME enablement access system and a customer application environment, and wherein all communications network traffic traverses a secure path utilizing a middle tier service provider CME portal, and wherein the customer interface utilizes a secure communications network connection;
(d) storing information and updating processes related to the entitled user in a CME support system to reflect the addition of a new entitled employee record;
(e) connecting partners for supporting the entitled user to the CME support System through the middle tier service provider CME portal, wherein a partner interface to the middle tier service provider CME portal is through a secure communications network connection, and wherein entitled users receive required products and access while they are remote and connected through a public wireless communications network; and,
(f) selectively notifying at least one of the entitled user and the customer.

39. An article of manufacture comprising a program storage medium readable by a computer and embodying one or more instructions executable by the computer to perform integrated method steps for executing commands to deploy computing products to pervasive computing devices, the integrated method comprising the steps of:
(a) providing a middle tier service provider for CME services;
(b) modifying, by the middle tier service provider, standard CME portal system templates and storing the modified templates into a CME fulfillment system, wherein the modifying provides a personal feel to the CME portal system for authorized corporate employees;
(c) enabling, by the middle tier service provider, access to the modified CME portal by assigning a unique corporate wide user ID and password that can be used by authorized users to request CME services;
(d) inputting, by an authorized user, identifying information such as, but not limited to, name, contact information, work location and employee type for requesting service, wherein the information is inputted through the modified CME portal utilizing a UGI, such as a browser, and stored within a CME fulfillment system;
(e) executing an entitlement process, wherein the entitlement process is an electronic workflow driven process that entails the middle tier service provider notifying a customer agent of pending requests that are ready for processing and customer agents interact with the CME Fulfillment system through a UGI, and, depending upon an outcome of the entitlement process, steps for an entitled user are selectively executed comprising:
(i) entitling the authorized user as an entitled user;
(ii) completing, by the entitled user, a personalized profile, providing information including, but not limited to, selectively requested approved products, shipping address and service activation;
(iii) forwarding, by the middle tier service provider, batch hardware and software requests to appropriate vendor partners fulfillment systems;
(iv) storing within the fulfillment system information related to each request;
(v) interacting, by the vendor partners, with the CME fulfillment system through a secure communications network connection through a partner CME portal;
(vi) giving each approved vendor and system access rights to the CME fulfillment system through a CME SecurePar system for supporting fulfillment and CME service transactions; and,
(vii) activating the entitled user;
or steps for a non-entitled user are selectively executed comprising:
(viii) initiating an automatic review process according to contract agreements;
(ix) approving or denying the request;
(x) executing steps (i)-(vii) for an entitled user if the request is approved; and,
(xi) selectively removing the authorized user from the CME portal system if the request is denied;
(f) notifying the authorized user of approval of the request or of a reason for denial of the request;
(g) loading an entitled user profile into an enablement support system;
(h) creating entitled user accounts;
(i) defining secure communications network paths based on the entitled user's corporation and applications, wherein the secure paths are defined between a CME enablement access system and a customer application environment, and wherein all communications network traffic traverses a secure path utilizing a middle tier service provider CME portal, and wherein the customer interface utilizes a secure communications network connection;
(j) storing information and updating processes related to the entitled user in a CME support system to reflect the addition of a new entitled employee record;
(k) connecting partners for supporting the entitled user to the CME support System through the middle tier service provider CME portal, wherein a partner interface to the middle tier service provider CME portal is through a secure communications network connection, and wherein entitled users receive required products and access while they are remote and connected through a public wireless communications network;
(l) selectively notifying at least one of the entitled user and the customer;
(m) incorporating relevant restrictions, limitations and conditions of service into a CME system according to an account contract;
(n) customizing, by a middle tier service provider, a set of management reports based on a standard set of templates that the middle tier service provider uses for reporting status of the account to both middle tier service provider management and partners and to customer agents;
(o) creating, by the middle tier service provider, customer contract specific provider and partner management reports;
(p) creating, by the middle tier service provider, customer profile specific reports; and,
(q) resolving, by the middle tier service provider and partners, any service delivery issues, wherein the middle tier service provider and partners work from the same information; wherein steps (a)-(q) are integrated in a manner wherein steps (a)-(f) provide for CME service fulfillment, steps (g)-(l) provide for CME service enablement, and steps (m)-(q) provide for account management.
